(19) United States
(12) Patent Application Publication
(10) Pub. No.: US 2013/0218723 A1
(43) Pub. Date: Aug. 22, 2013

(54) GLOBAL SHIPPING PLATFORM

(71) Applicants: Faisal Masud, Sammamish, WA (US); Sharif Sleiman, San Jose, CA (US); Kelli Aitchison, San Francisco, CA (US); Manish Joneja, San Jose, CA (US); Prakash Muppirala, San Jose, CA (US); Sanjay Narang, Foster City, CA (US); Madhusudan Varadan, Fremont, CA (US)

(72) Inventors: Faisal Masud, Sammamish, WA (US); Sharif Sleiman, San Jose, CA (US); Kelli Aitchison, San Francisco, CA (US); Manish Joneja, San Jose, CA (US); Prakash Muppirala, San Jose, CA (US); Sanjay Narang, Foster City, CA (US); Madhusudan Varadan, Fremont, CA (US)

(73) Assignee: eBay Inc., San Jose, CA (US)

(21) Appl. No.: 13/589,850

(22) Filed: Aug. 20, 2012

Related U.S. Application Data
(60) Provisional application No. 61/601,860, filed on Feb. 22, 2012.

(51) Int. Cl. G06Q 50/28; G06Q 30/00

(52) U.S. Cl. 705/26.62; 705/27.1

(57) ABSTRACT

A system and method for a global shipping platform for an online marketplace is described. A transaction between an international buyer and a domestic seller for an item listed by the domestic seller in the online marketplace is generated. A domestic shipping transaction of the transaction is generated for the domestic seller. An international shipping transaction of the transaction is generated for the international buyer.

### RELATED APPLICATION

The present application claims priority to U.S. Provisional Patent Application Ser. No. 61/601,860, filed Feb. 22, 2012, which is incorporated herein by reference in its entirety for all purposes.

### TECHNICAL FIELD

This application relates generally to the field of computer technology, and in a specific example embodiment, to a method and system for a global shipping platform.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

However, cross-border sellers and buyers are faced with a variety of tasks when the item ordered is being shipped internationally across multiple nations. Delays may arise from the multiple stops and transition of the item between the multiple stops. Furthermore, customs forms and codes further complicate and add inefficiency to the transaction.

### BRIEF DESCRIPTION OF THE DRAWINGS

The present disclosure is illustrated by way of example, and not by way of limitation, in the figures of the accompanying drawings in which:

FIG. 1 is a network diagram depicting a network system, according to one example embodiment, having a client-server architecture configured for exchanging data over a network;

FIG. 2 is a block diagram illustrating one example embodiment of a marketplace application;

FIG. 3A is a block diagram illustrating one example embodiment of a global shipping platform application;

FIG. 3B is a block diagram illustrating another example embodiment of a global shipping platform application;

FIG. 4 is a block diagram illustrating one example embodiment of a listing module;

FIG. 5 is a block diagram illustrating one example embodiment of a buying module;

FIG. 6 is a block diagram illustrating one example embodiment of a fulfilment module;

FIG. 7 is a block diagram illustrating one example embodiment of a financial reconciliation module;

FIG. 8 is a flow diagram illustrating one example embodiment of a method for a global shipping platform application;

FIG. 9 is a flow diagram illustrating another example embodiment of a method for a global shipping platform application;

FIG. 10 is a flow diagram illustrating one example embodiment of a method for a listing module;

FIG. 11 is a flow diagram illustrating one example embodiment of a method for a buying module;

FIG. 12 is a flow diagram illustrating one example embodiment of a method for a fulfilment module;

FIG. 13 is a flow diagram illustrating one example embodiment of a method for a cross-border dock;

FIG. 14 is a flow diagram illustrating one example embodiment of a method for a financial reconciliation module;

FIG. 15 is an example screenshot of a buyer user interface with the global shipping platform application; and

FIG. 16 shows a diagrammatic representation of machine in the example form of a computer system within which a set of instructions may be executed to cause the machine to perform any one or more of the methodologies discussed herein.

### DETAILED DESCRIPTION

Although the embodiments of the invention in the present disclosure are described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for a global shipping platform for an online marketplace is described. A transaction between an international buyer and a domestic seller for an item listed by the domestic seller in the online marketplace is generated. A domestic shipping transaction of the transaction is generated for the domestic seller. An international shipping transaction of the transaction is generated for the international buyer.

In one example embodiment, a domestic shipping address is generated for the domestic seller to ship the item to. The domestic shipping cost corresponding to the domestic shipping transaction is calculated. A total shipping cost corresponding to the international shipping transaction and the domestic shipping transaction is calculated for the seller. The total shipping cost includes duties and taxes based on the transaction.

In another example embodiment, transactions eligible for a Global Shipping Platform (GSP) are determined. Payment information for the item listed by the domestic seller is received from the international seller. The domestic shipping transaction and the international shipping transaction are generated. The payment information, the domestic shipping transaction, and the international shipping transaction are reconciled with the transaction.

### System Architecture

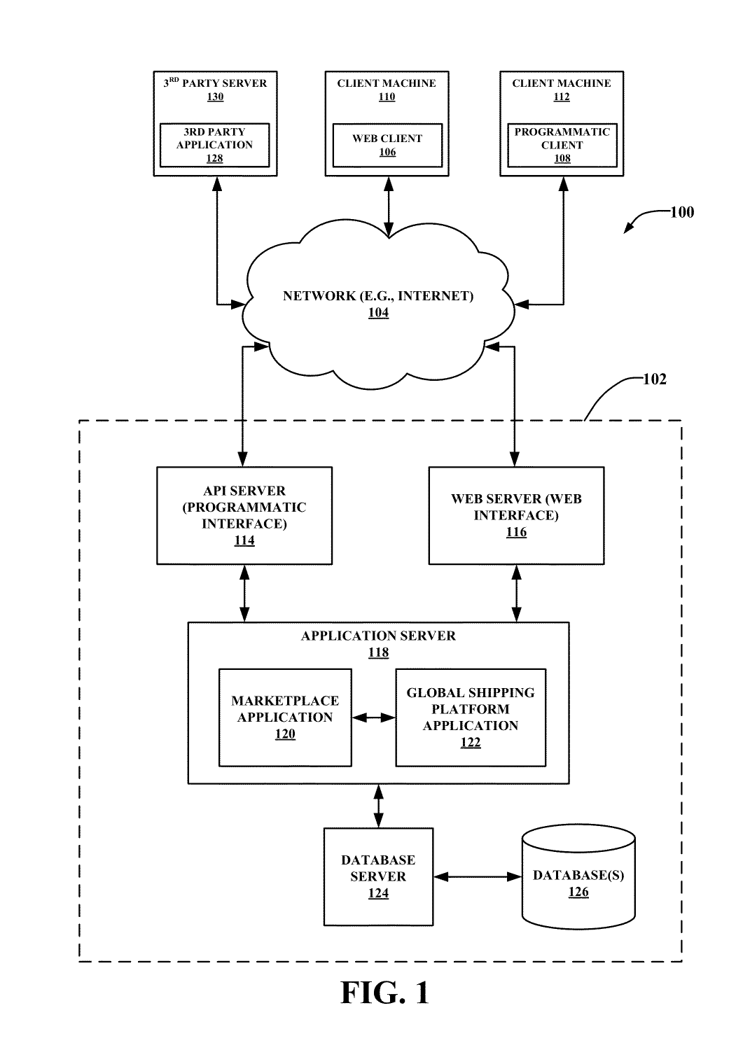

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a global shipping platform (GSP) application 122, may provide server-side functionality, via a network 104 (e.g., the Internet) to one or more clients. The one or more clients may include users that utilize the network system 100 and more specifically, the marketplace application 120 and the GSP application 122, to exchange data over the network 104. These transactions may include transmitting, receiving (i.e., communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among other things.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third-party server 130 with a third-party application 128. It can be appreciated that in various embodiments the client machines 110, 112, or third-party server 130 may be associated with a buyer, a seller, a third-party electronic commerce platform, a payment service provider, a shipping service provider, a financial institution system, each in communication with the network-based publisher 102 and optionally each other. The buyers and sellers may be any one of individuals, merchants, or service providers, among other things.

Turning specifically to the marketplace application 120 and the GSP application 122, an application program interface (API) server 114 and a web server 116 are coupled to, and provide programmatic and web interfaces respectively to, one or more application servers 118. The application server(s) 118 hosts one or more marketplace applications 120 and the GSP application 122. The application server(s) 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third-party application 128) running on another client machine (e.g., client machine 112 or third-party server 130).

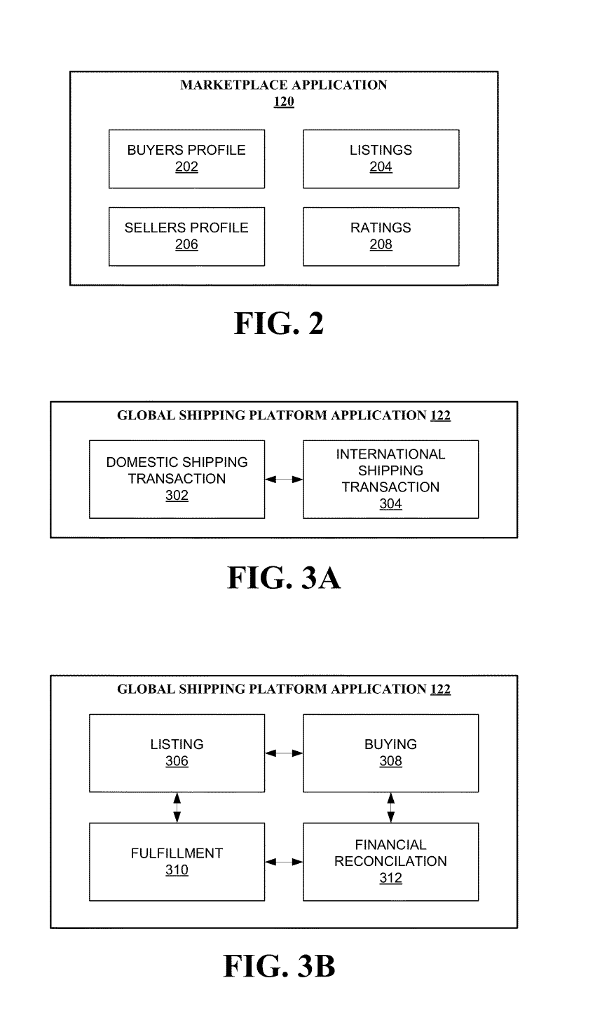

In one embodiment, the marketplace application 120 provides listings and price-setting mechanisms whereby a user may be a seller or buyer who lists or buys goods and/or services (e.g., for sale) published on the marketplace application 120. The marketplace application 120 is described in more details below with respect to FIG. 2.

In one embodiment, the GSP application 122 generates a transaction between an international buyer and a domestic seller for an item listed by the domestic seller in the online marketplace. A domestic shipping transaction of the transaction is generated for the domestic seller. An international shipping transaction of the transaction is generated for the international buyer. The GSP application 122 is described in more details below with respect to FIG. 3A and FIG. 3B.

FIG. 2 shows a block diagram illustrating one example embodiment of the marketplace application 120. The marketplace application 120 includes, for example, a buyers profile module 202, a listings module 204, a sellers profile module 206, and a ratings module 208.

The buyers profile module 202 may be configured to generate and store profiles of buyers of the marketplace application 120. For example, the profiles of the buyers may include names, addresses (including shipping address), and transaction history.

The listings module 204 may be configured to generate and store listings from the sellers. The listings may identify items for sale in the marketplace application 120 including the price, condition of the items, and shipping information.

The sellers profile module 206 may be configured to generate and store profiles of sellers of the marketplace application 120. For example, the profiles of the sellers may include names, addresses (including shipping address), and transaction history.

The ratings module 208 may be configured to generate and store ratings, including feedback ratings of buyers and sellers. In another embodiment, the ratings module 208 may also be configured to generate transaction volume and shipping volume on the marketplace application 120, or any other online marketplace.

FIG. 3A is a block diagram illustrating one example embodiment of the global shipping platform application 122 of FIG. 1. The global shipping platform application 122 includes a domestic shipping transaction module 302 and international shipping transaction module 304. When an international buyer places an order for an item listed by a domestic seller in an online marketplace, a commercial transaction is generated. In particular, the commercial transaction includes a domestic shipping transaction for the domestic seller, and an international shipping transaction for the international buyer. As such, the commercial transaction is presented as a domestic shipping transaction to the domestic seller and an international shipping transaction to the international buyer. One advantage of presenting the domestic shipping transaction to the domestic seller is that the domestic seller is shielded from the complexities associated with international shipping procedures such as taxes, duties, fees, customs, among others. Such complex international shipping procedures can be a deterrent for domestic seller to sell to international buyers.

The domestic shipping transaction module 302 generates a domestic shipping transaction for the domestic seller. In one example embodiment, the domestic shipping transaction module 302 generates a domestic shipping address for the domestic seller to ship the item to. The domestic shipping address may include a local or regional shipping address to the domestic seller (e.g., within the same country). The domestic shipping transaction module 302 calculates the domestic shipping cost corresponding to the domestic shipping transaction.

For example, domestic sellers are defaulted into the international shipping in a seamless manner when selling to an international buyer. The GSP platform application 122 automatically generates Harmonized System Codes (e.g., tariff, duty) for the items being listed. The online marketplace takes the ownership of complexity for calculating total Fully Landed, Duty Paid cost. Once the item is sold, a shipping label printing platform from the online marketplace application may also provide end-to-end shipping label to the domestic seller. The domestic seller can also use any other shipping label with tracking to ship to the nearest cross-dock of an international shipping service carrier. Domestic sellers are not charged for international shipping cost and duty and taxes.

The international shipping transaction module 304 generates an international shipping transaction for the international buyer. In one example embodiment, the international shipping transaction module 304 calculates the total shipping cost corresponding to the international shipping transaction. The total shipping cost includes duties, taxes, and other fees based on the transaction using information such as the nature of the item to be shipped, the weight and dimensions of the item or package, the selling price of the item, origin and destination addresses, origin countries, destination countries, and so forth.

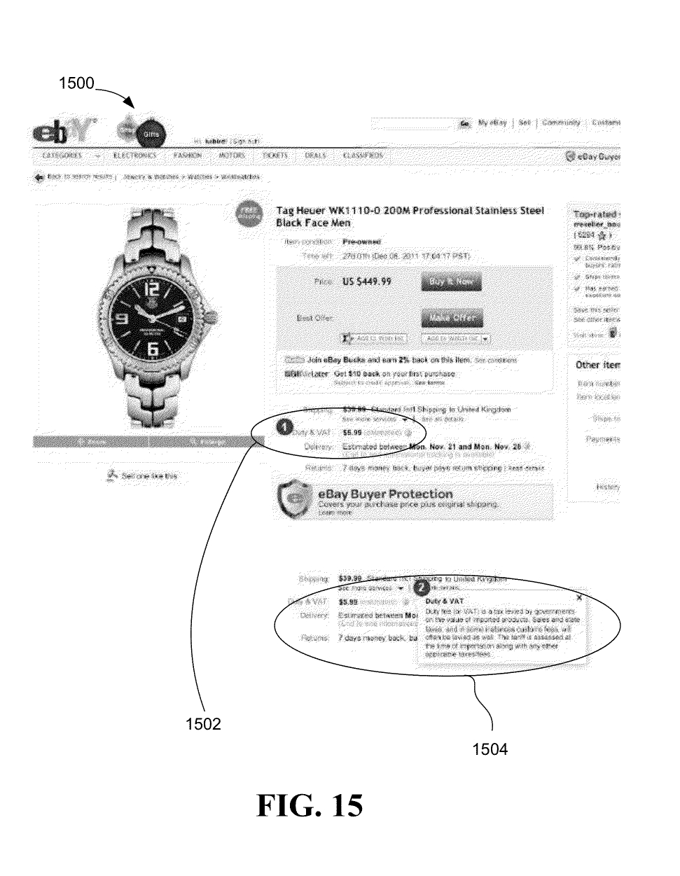

For example, the international buyer searches for an item and sees a Landed, Duty Paid Cost (LDP) 1502 and 1504 on the View Item page 1500 as illustrated in FIG. 15. The international buyer pays the entire amount for the item including LDP costs (inclusive of shipping) during checkout. There are no extra charges to the international buyer on arrival of the shipment as the LDP was guaranteed during checkout.

FIG. 3B is a block diagram illustrating another example embodiment of the global shipping platform application 122 of FIG. 1. The global shipping platform application 122 includes a listing module 306, a buying module 308, a fulfilment module 310, and a financial reconciliation module 312.

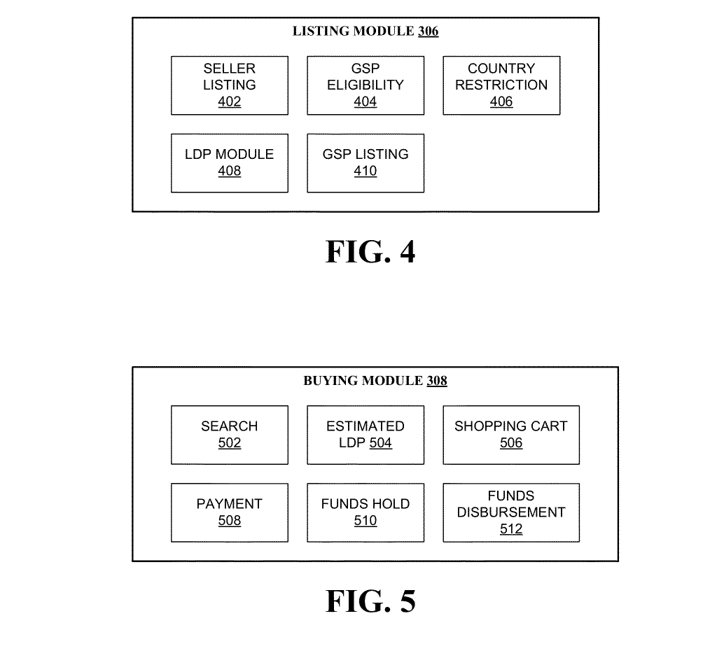

The listing module 306 determines transactions eligible for global shipping platform application 122. Listings from the domestic seller may include item classification, new data attributes to calculate international shipping cost, duty/taxes, item export/import restrictions to various countries. The listing module 306 is described further below with respect to FIG. 4.

The buying module 308 receives payment information for the item listed by the domestic seller from the international buyer. The international buyer may be able to buy the item on the online marketplace if the item is eligible to ship to that country. An item visibility flag may be set based on seller exclusion list (Worldwide) and restriction check for GSP countries. The buying module 308 is described further below with respect to FIG. 5.

The fulfilment module 310 generates the domestic shipping transaction and the international shipping transaction. The fulfilment module 310 may verify the following:

Package contents to be clearly defined (e.g. partial vs. full order);

Country of Origin (COO) to be specified by the seller or the GSP application as part of listing/fulfillment. In absence of COO, an international shipping service provider may open the package and may charge additional fees to the online marketplace and/or the domestic seller;

Orders from same buyer are not to be combined into one package for international shipping because combining orders can cause increased duty and taxes;

If a domestic seller decides to split an order, shipping cost and duty/taxes quoted by the international shipping service carrier may not match and the domestic seller may be responsible for any increased shipping cost and duty/taxes;

Seller may ship consolidate GSP orders into one box for domestic shipping. This can save sellers cost on domestic shipping. However, each package in the carton may have a “custom label” to identify the package correctly;

International shipping service provider may seek advance notice on packages arriving into the shipping service provider warehouse to prepare for fulfillment;

The domestic seller may ship the package to a warehouse of the international shipping service carrier using domestic shipping service with tracking; and

After the item is sold, the domestic seller can fulfill the order by either:

Printing a shipping label from the online marketplace; or

Printing a shipping label outside of the online marketplace printing platform.

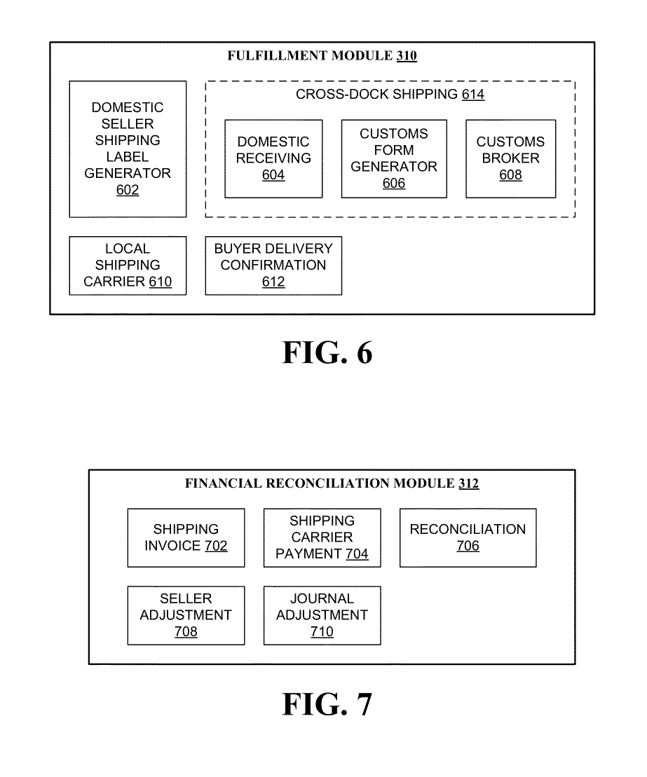

The fulfilment module 310 is described further below with respect to FIG. 6.

The financial reconciliation module 312 reconciles the payment information, the domestic shipping transaction, and the international shipping transaction with the transaction. For example, the financial reconciliation module 312 keeps track of the following transactions:

Domestic seller is charged final value fee (FVF is based on a percentage of the final selling price) on item cost for international transactions. FVF is not charged for international shipping cost and duty/taxes.

International buyers make one payment for the item, the shipping cost (domestic and international), and duties/taxes. The cost of the item and the domestic shipping cost is disbursed to the domestic seller whereas the international shipping cost and duties/taxes are disbursed to a holding account;

The international shipping service carrier invoices daily for items shipped internationally and duty/tax charges. On receipt of the invoice, GSP application 122 generates daily electronic funds payout to the international shipping service carrier, reconciles transactions to ensure correct invoices from the international shipping service carrier, and charges any post-manifestation charges to the domestic seller.

The financial reconciliation module 312 is described further below with respect to FIG. 7.

FIG. 4 is a block diagram illustrating one example embodiment of the listing module 306 of FIG. 3B. As part of qualifying an item for export from, for example, the United States, and import into destination countries, the items being sold are classified. As part of the classification process, every item is assigned a Harmonized System (HS Code) code. There are around 6000 unique HS Codes that can classify all items.

The HS Code is a commodity classification system in which articles are grouped largely according to the nature of the materials of which they are made, as has been traditional in customs nomenclatures. The HS Code is used as a basis for the customs tariffs and for the collection of international trade statistics. This coding system ensures that customs officials all around the world are referring to the same item when classifying a product and applying a tariff rate. The HS assigns six-digit codes that represent general categories of goods. All countries adhering to the HS use the same six-digit code for each product. However, a country can assign its own additional four numbers, making the entire code 10 digits. The first six digits of the HS code is recognized by all countries under the WCO (World Customs Organization). Other companies that support GSP have HS code as part of the catalog. Once the HS code is defined, customs and duty can be calculated for destination countries.

All countries need a Certificate of Origin (COO) to determine what duty or tariff, if any, should be assessed on the product or products being imported. The U.S. has trade agreements with many foreign countries, and under the terms of many of these agreements, American products receive lower tariff rates or are not subject to a tariff. The foreign customs office verifies whether a product qualifies for preferential duty rates based on the information on the Certificate of Origin that accompanies the documentation associated with the shipment. Also, some countries have banned certain products from countries that have been caught dumping. The COO helps prove that the product is allowed into that particular country.

The listing module 306 includes a seller listing module 402, a GSP eligibility module 404, a country restriction module 406, a duties and taxes module (also referred to as Landed Duties Paid (LDP) module) 408, and a GSP listing module 410.

The seller listing module 402 generates a listing in the online marketplace for the item of the domestic seller based on data from the marketplace application 120 of FIG. 2. For example, any items listed on an online marketplace (e.g., eBay.com) with item location as USA may be eligible for GSP as the international service. Buyers can buy the GSP items from eBay.com or other eBay sites like eBay.co.uk, ebay.co.ca depending on item visibility flag set during listing.

The GSP eligibility module 404 verifies eligibility of the domestic seller qualification and the item qualification for the GSP. The seller qualification for GSP on their listings may be based on seller performance level (e.g., above standard, standard, and below standard). The item qualification for GSP may be based on “Fixed Price” and Auction listings will be covered by the GSP.

By default, domestic sellers may be part of the GSP program.

Sellers with listing preference set to “no international shipping” may be defaulted into GSP service as GSP provides domestic shipping experience for international orders. However, some international sellers may continue to be opted-out for non-GSP countries.

Sellers with listing preference set to “Worldwide shipping” may be defaulted into GSP service as well as international shipping. Sellers may have two set of international shipping services:

GSP services for supported countries,

USPS/UPS/FedEx for non-GSP countries.

The country restriction module 406 determines restricted countries based on the item in the listing. There are two types of country exclusions:

Sellers who maintain country level exclusion on the online marketplace and decide to which countries they do not sell. GSP will honor seller settings and will not show GSP items to buyers of excluded countries; and

International shipping service carrier may restrict the items for export based on item description during item listing. GSP may honor the international shipping service carrier results and may not show GSP items to buyers of excluded countries.

The country restriction module 406 also provides functionality where a category and any sub-categories can be excluded from GSP.

The LDP module 408 computes or retrieves landed duties and taxes for the item corresponding to a country of the international buyer. Most countries use the CIF (Cost, Insurance and Freight) method to calculate duty charges. CIF is a pricing term that means the cost of the goods, insurance and freight (shipping charge) are included in the quoted price. The total duty and tax charge is calculated by adding all costs together. The computation may be performed by the LDP module 408 or may be performed by an external application (e.g., international shipping service carrier).

The GSP listing module 410 enables publication of a listing of an eligible domestic seller to international buyers of corresponding eligible countries on the online marketplace as previously discussed.

FIG. 5 is a block diagram illustrating one example embodiment of the buying module 308 of FIG. 3B. The buying module 308 may include a search module 502, an estimated landed duty paid cost module 504, a shopping cart module 506, a payment module 508, a funds hold module 510, and a funds disbursement module 512.

The search module 502 enables the international buyer to search for items.

When an international buyer searches for an item on the online marketplace, the search displays item cost and shipping cost for GSP items depending on the buyer's country. The shipping cost includes the domestic and international shipping cost. The domestic shipping cost is specified by the buyer (i.e., either flat or calculated) whereas the international shipping cost may be determined by an international shipping service carrier during item listing. Hence, the search caches shipping costs for all countries at the listing level. The search may not show duty and taxes cost in the search results. If buyer location is unknown, GSP application 122 shows a domestic buyer experience.

The estimated landed duty paid cost module 504 computes and displays an estimated landed duty paid cost to the international buyer based on the item.

For fixed price format: a View item function calls the shipping engine to check if LDP cost is to be displayed. View item replaces the existing shipping section to show International shipping. International buyer will see a Landed, Duty Paid Cost (LDP) on the View Item page. In some cases, duty and taxes can be zero, based on the importing country tariffs.

Also, the LDP cost may be an estimated cost (i.e., based on the listing attributes) because the LDP cost may change as the buyer may buy multiple quantities or may add items to shopping cart or can have multiple items in the cart. Buyers see guaranteed costs in their shopping cart and during checkout.

Delivery estimate range may be shown based on handling time, delivery estimate of domestic leg, and delivery estimate of international leg as provided by the international shipping service carrier.

For auction format: a View item function shows the link for buyer to input price and calculate LDP at that item price. A link is displayed next to the “Bid”/“Make offer” button to let the buyer know that LDP cost will be added to the auction won price (conceptually, it is similar to sales tax that gets added after the item is won in auction). In some cases, duty and taxes can be zero, based on the importing country tariffs.

The shopping cart module 506 recalculates the estimated landed duty paid cost based on items in a shopping cart of the online marketplace. LDP cost is associated at the item level. If the buyer has multiple items in the cart, some items may not have LDP cost.

The shopping cart module 506 may call an international shipping service carrier quoting engine to recalculate shipping and LDP cost at the cart level. LDP cost shown in the cart can be a guaranteed cost. The international shipping service carrier provides the LDP cost in all other GSP items in the cart. LDP cost may be attached to every item and the cart level LDP cost is the sum of item(s) LDP cost.

The payment module 508 receives payment from the international buyer for the transaction. The online marketplace calls the international shipping service carrier API to compute the guaranteed landed cost. If the buyer changes the ship to address or makes any changes to the cart, the international shipping service carrier API is called by the international shipping service carrier API again to calculate the LDP cost. Checkout will show Duty/Taxes for the GSP items at the item and order level. If buyer updates shipping address or items in the cart, checkout will continue to call shipping service to recalculate shipping cost.

When user clicks on “Continue” from order page, the online marketplace asynchronously calls the international shipping service carrier to create an order in the international shipping service carrier system. In addition, the online marketplace validates the buyer's shipping address with the international shipping service carrier API.

Payment module 508, also referred to as “checkout,” groups the items in the cart by shipping service. Hence, when a shopping cart has GSP and non-GSP items, checkout uses the existing logic to group items into different orders. Buyer continues to see existing behavior of different orders grouped by shipping service. In case of “Commit to buy” and “Pay later” use case, duty and taxes will be charged as applicable on the payment date.

The funds hold module 510 divides the payment according to the domestic shipping transaction and the international shipping transaction. The international buyer pays the entire amount for the item including LDP costs (inclusive of shipping) during checkout. The international buyer can pay by any payment method (e.g., credit card). The domestic seller receives item cost and domestic shipping cost whereas international shipping cost plus duty/taxes cost will be disbursed to the online marketplace account.

The international buyer should see one payment transaction in the selected payment instrument history. Sellers are not charged FVF on International shipping cost and duty/taxes.

The funds disbursement module 512 issues a first payment to the seller including the domestic shipping cost, and a second payment to a cross-dock shipping agent including the international shipping cost and the duties and taxes.

After the payment is successfully captured, the online marketplace confirms the payment with the international shipping service carrier. The international shipping service carrier stores the confirmed GSP order with guaranteed landed cost as they plan for the fulfillment. Also, a local domestic warehouse of the international shipping service carrier is assigned to the order.

FIG. 6 is a block diagram illustrating one example embodiment of the fulfilment module 310 of FIG. 3B. The fulfilment module 310 includes a domestic seller shipping label generator 602, a cross-dock shipping module 614, a local shipping carrier module 610, and a buyer delivery confirmation module 612.

The domestic seller shipping label generator 602 generates a domestic shipping label for the domestic seller to ship the item to a warehouse local to the domestic seller.

The cross-dock shipping module 614 receives the item for the domestic shipping transaction at the local warehouse and transits the item for the international shipping transaction.

The local shipping carrier module 610 generates a local carrier shipping transaction in a local country of the international buyer.

The buyer delivery confirmation module 612 generates a confirmation of a delivery of item at a receiving address of the international buyer.

The cross-dock shipping module 614 includes a domestic receiving module 604, a customs form generator 606, and a customs broker module 608. The domestic receiving module 604 detects a delivery of the item at the warehouse local to the domestic seller. The customs form generator 606 generates and prints a customs form using data from the transaction between the international buyer and the domestic seller. The customs broker module 608 communicates the customs form to a customs broker to facilitate the international shipping transaction.

FIG. 7 is a block diagram illustrating one example embodiment of a financial reconciliation module 312 of FIG. 3B. The financial reconciliation module 312 includes a shipping invoice module 702, a shipping carrier payment module 704, a reconciliation module 706, a seller adjustment module 708, and a journal adjustment module 710.

The shipping invoice module 702 generates shipping invoices from an international shipping carrier corresponding to the international shipping transaction and a domestic shipping carrier corresponding to the domestic shipping transaction.

The shipping carrier payment module 704 generates a payment to the international shipping carrier and the domestic shipping carrier.

The reconciliation module 706 reconciles shipping invoices.

The seller adjustment module 708 adjusts the domestic seller invoice with the shipping invoices.

The journal adjustment module 710 enters financial transactions from the shipping invoices and the adjusted domestic seller invoice in an accounting journal.

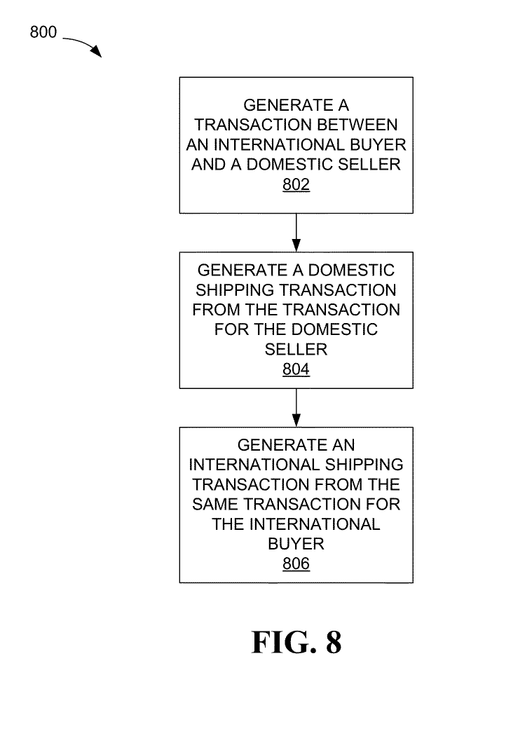

FIG. 8 shows a flow diagram illustrating one example embodiment of a method 800 for a global shipping platform. At operation 802, an online marketplace generates a commercial transaction between a domestic seller and an international buyer. At operation 804, a domestic shipping transaction is generated based on the commercial transaction to the domestic seller. In other words, the online shipping transaction is presented as a domestic shipping transaction to the domestic seller. In one embodiment, the domestic seller is directed to ship to a local domestic location where it will subsequently be shipped internationally to the international seller. At operation 806, an international shipping transaction is generated based on the commercial transaction to the international buyer. In other words, the online shipping transaction is presented as an international shipping transaction to the international buyer. The international buyer is presented with an estimated shipping total that includes duties, taxes, and other fees associated with the international shipping transaction.

In one embodiment, a domestic shipping address is generated for the domestic seller to ship the item to. The domestic shipping address may correspond to the local domestic address of a warehouse or cross-dock or transit of an international shipping service carrier. In one embodiment, the domestic shipping cost corresponding to the domestic shipping transaction is calculated. A total shipping cost corresponding to the international shipping transaction and the domestic shipping transaction for the seller is also calculated where the total shipping cost includes duties and taxes based on the transaction.

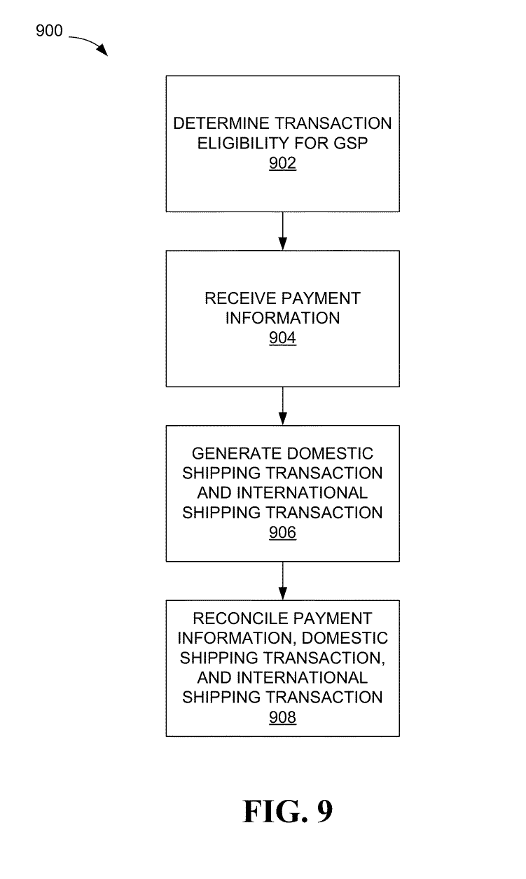

FIG. 9 is a flow diagram illustrating another example embodiment of a method 900 for a global shipping platform application. At operation 902, the global shipping platform application determines whether the transaction is eligible for the GSP. At operation 904, payment information for the item listed by the domestic seller is received from the international seller. At operation 906, the global shipping platform application generates the domestic shipping transaction and the international shipping transaction. At operation 908, the global shipping platform application reconciles the payment information, the domestic shipping transaction, and the international shipping transaction with the transaction.

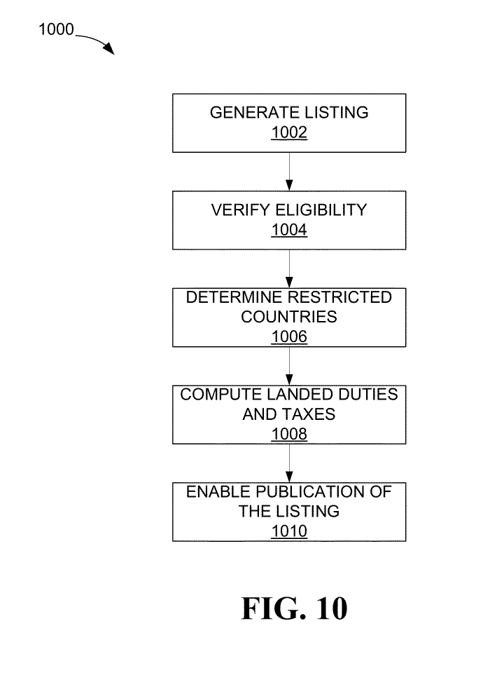

FIG. 10 is a flow diagram illustrating one example embodiment of a method 1000 for the listing module 306 of FIG. 3B. At operation 1002, the listing module generates a listing in the online marketplace for the item of the domestic seller. At operation 1004, the listing module 306 verifies eligibility of the domestic seller qualification and the item qualification for the GSP. At operation 1006, the listing module 306 determines restricted countries based on the item in the listing. At operation 1008, the listing module 306 computes landed duties and taxes for the item corresponding to a country of the international buyer. At operation 1010, the listings module 306 enables publication of a listing of an eligible domestic seller to international buyers of corresponding eligible countries.

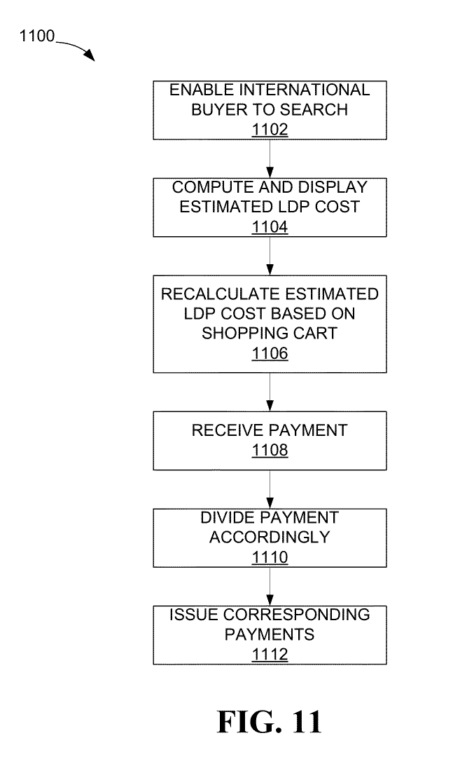

FIG. 11 is a flow diagram illustrating one example embodiment of a method 1100 for the buying module 308 of FIG. 3B. At operation 1102, the buying module 308 enables the international buyer to search for items. At operation 1104, the buying module 308 computes and displays an estimated landed duty paid cost to the international buyer based on the item. At operation 1106, the buying module 308 recalculates the estimated landed duty paid cost based on items in a shopping cart of the online marketplace. At operation 1108, the buying module 308 receives payment from the international buyer for the transaction. At operation 1110, the buying module 308 divides the payment according to the domestic shipping transaction and the international shipping transaction. At operation 1112, the buying module 308 issues a first payment to the seller including the domestic shipping cost, and a second payment to a cross-dock shipping agent including the international shipping cost and the duties and taxes.

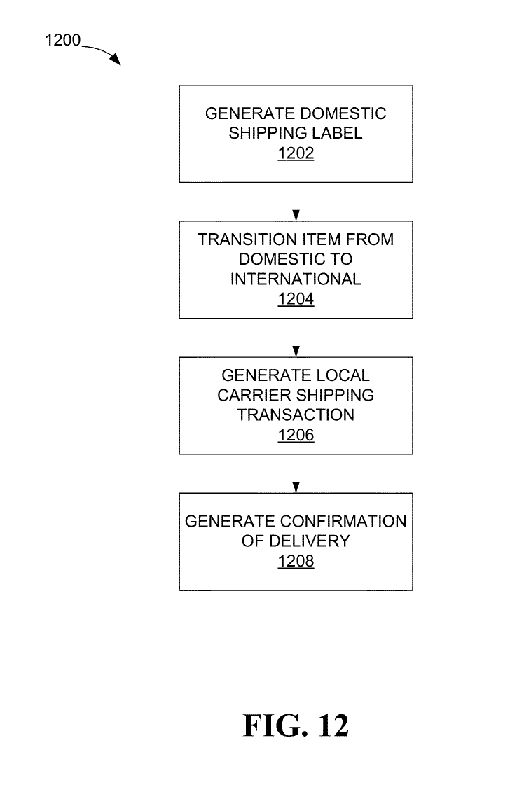

FIG. 12 is a flow diagram illustrating one example embodiment of a method 1200 for the fulfilment module 310 of FIG. 3B. At operation 1202, the fulfilment module 310 generates a domestic shipping label for the domestic seller to ship the item to a warehouse local to the domestic seller. At operation 1204, the fulfilment module 310 transitions the item from the domestic shipping transaction to the international shipping transaction. At operation 1206, the fulfilment module 310 generates a local carrier shipping transaction in a local country of the international buyer. At operation 1208, the fulfilment module 310 generates a confirmation of a delivery of item at a receiving address of the international buyer.

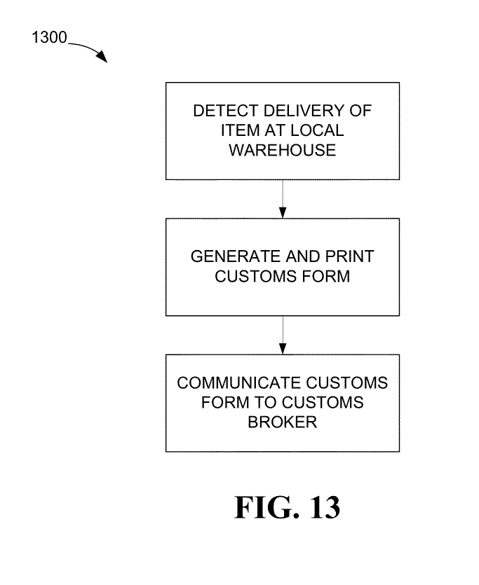

FIG. 13 is a flow diagram illustrating one example embodiment of a method 1300 for the cross-dock shipping module 614 of FIG. 6. At operation 1302, the cross-dock shipping module 614 detects a delivery of the item at the warehouse local to the domestic seller. At operation 1304, the cross-dock shipping module 614 generates and prints a customs form using data from the transaction between the international buyer and the domestic seller. At operation 1306, the cross-dock shipping module 614 communicates the customs form to a customs broker to facilitate the international shipping transaction.

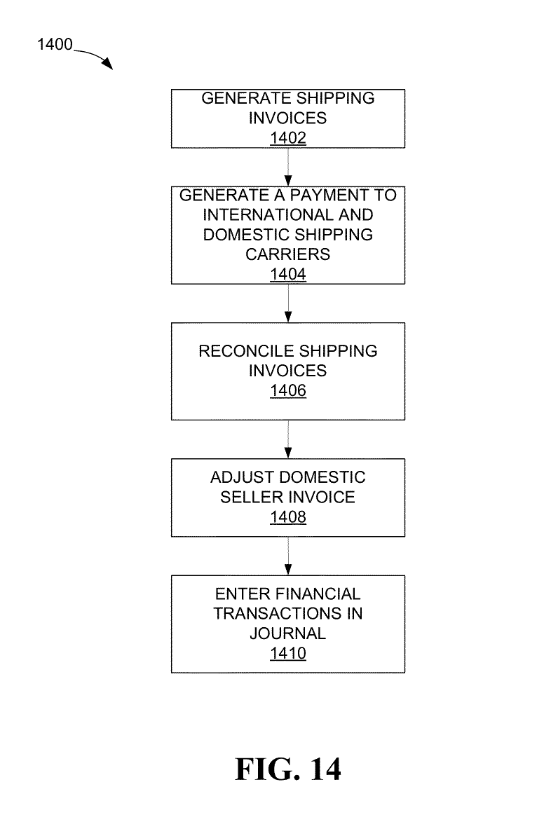

FIG. 14 is a flow diagram illustrating one example embodiment of a method 1400 for the financial reconciliation module 312 of FIG. 3B. At operation 1402, the financial reconciliation module 312 generates shipping invoices from an international shipping carrier corresponding to the international shipping transaction and a domestic shipping carrier corresponding to the domestic shipping transaction. At operation 1404, the financial reconciliation module 312 generates a payment to the international shipping carrier and the domestic shipping carrier. At operation 1406, the financial reconciliation module 312 reconciles shipping invoices. At operation 1408, the financial reconciliation module 312 adjusts the domestic seller invoice with the shipping invoices. At operation 1410, the financial reconciliation module 312 enters financial transactions from the shipping invoices and the adjusted domestic seller invoice in an accounting journal.

### Example Computer System

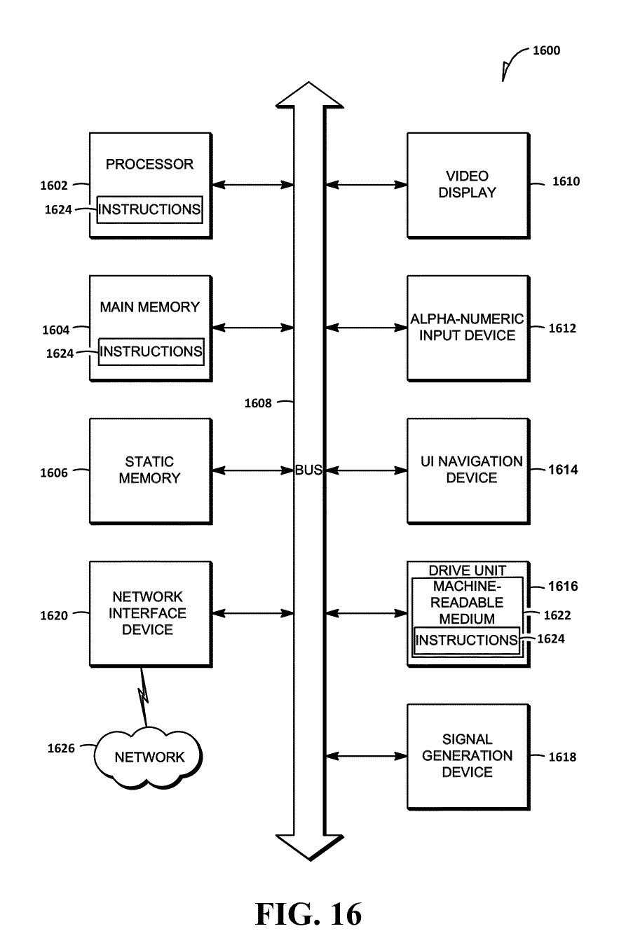

FIG. 16 shows a diagrammatic representation of a machine in the example form of a computer system 1600 within which a set of instructions 1624 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a user interface (UI) navigation device 1614 (e.g., a mouse), a disk drive unit 1616, a signal generation device 1618 (e.g., a speaker) and a network interface device 1620.

The disk drive unit 1616 includes a machine-readable medium 1622 on which is stored one or more sets of data structures and instructions 1624 (e.g., software) embodying or utilized by any one or more of the methodologies or functions described herein. The instructions 1624 may also reside, completely or at least partially, within the main memory 1604 and/or within the processor 1602 during execution thereof by the computer system 1600, with the main memory 1604 and the processor 1602 also constituting machine-readable media.

The instructions 1624 may further be transmitted or received over a network 1626 via the network interface device 1620 utilizing any one of a number of well-known transfer protocols (e.g., HTTP).

While the machine-readable medium 1622 is shown in an example embodiment to be a single medium, the term “machine-readable medium” should be taken to include a single medium or multiple media (e.g., a centralized or distributed database, and/or associated caches and servers) that store the one or more sets of instructions 1624. The term “machine-readable medium” shall also be taken to include any medium that is capable of storing, encoding or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical media, and magnetic media.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a marketplace module configured to generate a transaction between an international buyer and a domestic seller for an item listed by the domestic seller in an online marketplace; and
a global shipping platform (GSP) module configured to generate a domestic shipping transaction for the domestic seller and an international shipping transaction for the international buyer as part of the global shipping platform.

2. The system of claim 1, wherein the GSP module comprises:
a domestic shipping transaction module configured to generate a domestic shipping address for the domestic seller to ship the item to, and to compute a domestic shipping cost corresponding to the domestic shipping transaction; and
an international shipping transaction module to compute a total shipping cost corresponding to the international shipping transaction and the domestic shipping transaction for the seller, the total shipping cost comprising duties and taxes based on the transaction.

3. The system of claim 1, wherein the GSP module comprises:
a listing module configured to determine transactions eligible for the GSP;
a buying module configured to receive payment information for the item listed by the domestic seller from the international buyer;
a fulfillment module configured to generate the domestic shipping transaction and the international shipping transaction; and
a financial reconciliation module configured to reconcile the payment information, the domestic shipping transaction, and the international shipping transaction with the transaction.

4. The system of claim 3, wherein the listing module further comprises:
a seller listing module configured to generate a listing in the online marketplace for the item of the domestic seller;
a GSP eligibility module configured to verify eligibility of a domestic seller qualification and an item qualification for the GSP;
a country restriction module configured to determine restricted countries based on the item in the listing;
a duties and taxes module to configured to compute landed duties and taxes for the item corresponding to a country of the international buyer; and
a GSP listing module configured to enable publication of a listing of an eligible domestic seller to international buyers of corresponding eligible countries.

5. The system of claim 3, wherein the buying module further comprises:
a search module configured to enable the international buyer to search for items;
an estimated landed duty paid cost module configured to compute and display an estimated landed duty paid cost to the international buyer based on the item;
a shopping cart module configured to recalculate the estimated landed duty paid cost based on items in a shopping cart of the online marketplace;
a payment module configured to receive payment from the international buyer for the transaction;
a funds hold module configured to divide the payment according to the domestic shipping transaction and the international shipping transaction; and
a funds disbursement module configured to issue a first payment to the domestic seller including a domestic shipping cost, and a second payment to a cross-dock shipping agent including an international shipping cost and duties and taxes.

6. The system of claim 3, wherein the fulfillment module further comprises:
a domestic seller shipping label generator configured to generate a domestic shipping label for the domestic seller to ship the item to a warehouse local to the domestic seller;
a cross-dock shipping module configured to transit the item from the domestic shipping transaction to the international shipping transaction;
a local shipping carrier module configured to generate a local carrier shipping transaction in a local country of the international buyer; and
a buyer delivery confirmation module configured to generate a confirmation of a delivery of the item at a receiving address of the international buyer.

7. The system of claim 6, wherein the cross-dock shipping module further comprises:
a domestic receiving module configured to detect a delivery of the item at the warehouse local to the domestic seller;
a customs form generator configured to generate and print a customs form using data from the transaction between the international buyer and the domestic seller; and
a customs broker module configured to communicate the customs form to a customs broker to facilitate the international shipping transaction.

8. The system of claim 3, wherein the financial reconciliation module further comprises:
a shipping invoice module configured to generate shipping invoices from an international shipping carrier corresponding to the international shipping transaction and a domestic shipping carrier corresponding to the domestic shipping transaction;
a shipping carrier payment module configured to generate a payment to the international shipping carrier and the domestic shipping carrier;
a reconciliation module configured to reconcile shipping invoices;
a seller adjustment module configured to adjust a domestic seller invoice with the shipping invoices; and
a journal module configured to enter financial transactions from the shipping invoices and the adjusted domestic seller invoice in an accounting journal.

9. A computer-implemented method comprising:
generating a transaction between an international buyer and a domestic seller for an item listed by the domestic seller in an online marketplace; and
generating a domestic shipping transaction from the transaction for the domestic seller and an international shipping transaction from the transaction for the international buyer as part of a global shipping platform (GSP).

10. The computer-implemented method of claim 9, further comprising:
generating a domestic shipping address for the domestic seller to ship the item to;
computing a domestic shipping cost corresponding to the domestic shipping transaction; and
computing a total shipping cost corresponding to the international shipping transaction and the domestic shipping transaction for the seller, the total shipping cost comprising duties and taxes based on the transaction.

11. The computer-implemented method of claim 9, further comprising:
determining transactions eligible for the GSP;
receiving payment information for the item listed by the domestic seller from the international buyer;
generating the domestic shipping transaction and the international shipping transaction; and
reconciling the payment information, the domestic shipping transaction, and the international shipping transaction with the transaction.

12. The computer-implemented method of claim 11, wherein determining transactions further comprises:
generating a listing in the online marketplace for the item of the domestic seller;
verifying eligibility of domestic seller qualification and item qualification for the GSP;
determining restricted countries based on the item in the listing;
computing landed duties and taxes for the item corresponding to a country of the international buyer; and
enabling publication of a listing of an eligible domestic seller to international buyers of corresponding eligible countries.

13. The computer-implemented method of claim 11, wherein receiving payment information further comprises:
enabling the international buyer to search for items;
computing and displaying an estimated landed duty paid cost to the international buyer based on the item;
recalculating the estimated landed duty paid cost based on items in a shopping cart of the online marketplace;
receiving payment from the international buyer for the transaction;
dividing the payment according to the domestic shipping transaction and the international shipping transaction; and
issuing a first payment to the domestic seller including the domestic shipping cost, and a second payment to a cross-dock shipping agent including an international shipping cost and duties and taxes.

14. The computer-implemented method of claim 11, wherein generating the domestic shipping transaction and the international shipping transaction further comprises:
generating a domestic shipping label for the domestic seller to ship the item to a warehouse local to the domestic seller;
transitioning the item from the domestic shipping transaction to the international shipping transaction;
generating a local carrier shipping transaction in a local country of the international buyer; and
generating a confirmation of a delivery of the item at a receiving address of the international buyer.

15. The computer-implemented method of claim 14, further comprising:
detecting a delivery of the item at the warehouse local to the domestic seller;
generating and printing a customs form using data from the transaction between the international buyer and the domestic seller; and
communicating the customs form to a customs broker to facilitate the international shipping transaction.

16. The computer-implemented method of claim 11, wherein reconciling the payment information further comprises:
generating shipping invoices from an international shipping carrier corresponding to the international shipping transaction and a domestic shipping carrier corresponding to the domestic shipping transaction;
generating a payment to the international shipping carrier and the domestic shipping carrier;
reconciling the shipping invoices;
adjusting a domestic seller invoice with the shipping invoices; and
entering financial transactions from the shipping invoices and the adjusted domestic seller invoice in an accounting journal.

17. A non-transitory computer-readable storage medium storing a set of instructions that, when executed by a processor, cause the processor to perform operations, comprising:
generating a transaction between an international buyer and a domestic seller for an item listed by the domestic seller in an online marketplace; and
generating a domestic shipping transaction for the domestic seller and an international shipping transaction for the international buyer as part of a global shipping platform (GSP).

18. The non-transitory computer-readable storage medium of claim 17, further comprising:
generating a domestic shipping address for the domestic seller to ship the item to;
computing a domestic shipping cost corresponding to the domestic shipping transaction; and
computing a total shipping cost corresponding to the international shipping transaction and the domestic shipping transaction for the domestic seller, the total shipping cost comprising duties and taxes based on the transaction.

19. The non-transitory computer-readable storage medium of claim 18, further comprising:
determining transactions eligible for the GSP;
receiving payment information for the item listed by the domestic seller from the international buyer;
generating the domestic shipping transaction and the international shipping transaction; and
reconciling the payment information, the domestic shipping transaction, and the international shipping transaction with the transaction.

20. The non-transitory computer-readable storage medium of claim 17, further comprising:
presenting the transaction between the international buyer and the domestic seller as a domestic transaction to the domestic seller; and
presenting the transaction between the international buyer and the domestic seller as an international transaction to the international buyer.
